(19) United States
(12) Patent Application Publication
(10) Pub. No.: US 2017/0161181 A1
(43) Pub. Date: Jun. 8, 2017

(54) TESTING SUPPORT SYSTEM, AND TESTING SUPPORT METHOD

(71) Applicant: Hitachi, Ltd., Tokyo (JP)

(72) Inventors: Genta KOREKI, Tokyo (JP); Jun MAEOKA, Tokyo (JP); Hideki NAKAMURA, Tokyo (JP)

(21) Appl. No.: 15/071,675

(22) Filed: Mar. 16, 2016

(30) Foreign Application Priority Data
Dec. 4, 2015 (JP) 2015-237213

(51) Int. Cl. G06F 11/36

(52) U.S. Cl. CPC G06F 11/3688

(57) ABSTRACT

An object of the invention is to provide efficient testing of software. A testing support apparatus stores a plurality of test scenarios including description concerning transition of screens, source codes constituting the software, and screen/source code correspondence information representing correspondence between the screens and the source codes related to generation of the screens, generates test scenario dividing information which is information including the results of dividing the description of each test scenario into a plurality of blocks in terms of the screens, sets execution priority levels for the plurality of test scenarios based on the test scenario dividing information, and sequentially executes the test scenarios in accordance with the execution priority levels. The testing support apparatus sets the execution priority levels for the plurality of test scenarios for each screen based on a criterion.

### CROSS-REFERENCE TO RELATED APPLICATION(S)

The present application claims Convention priority from Japanese Patent Application No. 2015-237213 filed on Dec. 4, 2015, the full content of which incorporated herein by reference.

### BACKGROUND OF THE INVENTION

1. Field of the Invention

The present invention relates to a testing support system, and a testing support method.

2. Related Art

Japanese Patent Laid-open Publication No. 2008-204405 describes that: “In order to prevent the number of test items from being huge at regression testing, the regression testing system automatically extracts portions to be preferentially tested in accordance with modifications. This enables automatic and efficient regression testing”, “The regression testing system is configured to perform testing by storing information concerning test cases in past testing and combining the stored information and the dependence relation obtained by analyzing the target program”, and “With reference to the dependence relation between statements in a software program, which is stored in a storage unit, the information processing apparatus extracts a statement relating to a modified statement; detects a test case associated with the extracted statement from information about the correspondence between past test cases and statements in the software program, which is stored in the storage unit; and executes the detected test case.”

In the development site of software, to improve the quality and development efficiency, software developers have established development styles in which implementation of source codes and testing are repeatedly performed on the basis of functions. Application software such as Web applications implements a function with plural screens in some cases. Such software is often tested by executing a test scenario describing user's operations, including operations causing screen transition (operations for buttons and links, and the like), as a series of sequences.

However, at testing using such a test scenario, it is not easy to find the correspondence between screens and description of the test scenario or the correspondence between screens and source codes. Accordingly, projects to develop large-scale information processing systems which many developers are involved in particularly require a lot of time and effort to find bugs and specify the causes thereof, thus lowering the software development efficiency.

### SUMMARY OF THE INVENTION

The present invention is made in the light of the aforementioned background, and an object of the invention is to provide a testing support apparatus, and a testing support method which enable efficient software testing.

An aspect of the invention to achieve the aforementioned object is a testing support apparatus (an image processing apparatus) which supports testing of software, the apparatus including: a storage unit storing a plurality of test scenarios including description concerning transition of screens; source codes constituting the software, and screen/source code correspondence information representing the correspondence between the screens and the source codes related to generation of the screens, a test scenario division part configured to generate test scenario dividing information which is information including the results of dividing the description of each of the test scenarios into a plurality of blocks in terms of the screens, and a test scenario execution priority setting part which sets execution priority levels for the plurality of test scenarios based on the test scenario dividing information.

According to the present invention, it is made possible to test software efficiently.

### BRIEF DESCRIPTION OF THE DRAWINGS

FIG. 1 is a diagram illustrating a schematic configuration and function of an information processing system 1;

FIG. 2 is a block diagram of an information processing apparatus 10 illustrated as an example of hardware of a project information management apparatus 200 and a content provider apparatus 300;

FIG. 3 is an example of screen/source code correspondence information 151;

FIG. 4 is a screen layout corresponding to the screen/source code correspondence information 151 of FIG. 3;

FIG. 5 is an example of test scenario dividing information 153;

FIG. 6 is a diagram for explaining the number of screen hops;

FIG. 7 is an example of test scenario execution priority information 153;

FIG. 8 is a flowchart for explaining a test scenario execution process S800;

FIG. 9 is a flowchart for explaining the detail of a screen/source code correspondence information generation process S811 of FIG. 8;

FIG. 10A is an example of a screen definition script;

FIG. 10B is a description example of a source file (HTML file) with a file name of “top.html” which is described in the screen definition script of FIG. 10A;

FIG. 10C is a description example of a script file with a file name of “top.js”;

FIG. 11 is a flowchart for explaining the detail of a test scenario dividing information generation process S812 of FIG. 8;

FIG. 12A is an example of test scenarios 154;

FIG. 12B is examples of screens related to the test scenario 154 of FIG. 12A;

FIG. 13 is examples of the source codes of the screens illustrated in FIG. 12B; and

FIG. 14 is a diagram for explaining the result of dividing the description of the test scenario 154 illustrated in FIG. 12A on the basis of screens.

### DETAILED DESCRIPTION OF THE INVENTION

Hereinafter, a description is given of an embodiment with reference to the accompanying drawings. In the following description, the term “data base” is sometimes abbreviated as DB.

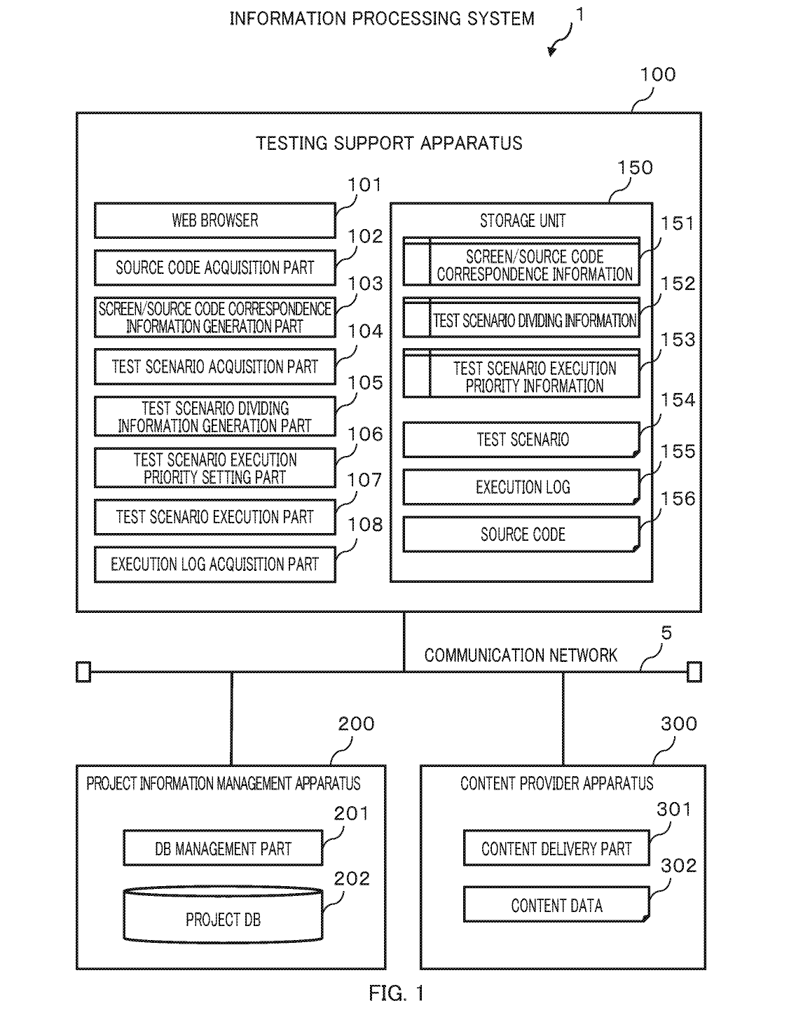

FIG. 1 illustrates a schematic configuration of an information processing system 1 described as an embodiment. The information processing system 1 includes a testing support apparatus 100, a project information management apparatus 200, and a content provider apparatus 300. These apparatuses are all information processing apparatuses (computers) and are coupled with each other through a communication network 5 so as to communicate with each other. The communication network 5 is a local area network (LAN), a wide area network (WAN), or the Internet, for example.

The testing support apparatus 100 supports testing of software performed by the user. In the description of this embodiment, software as an object to be tested by the testing support apparatus 100 is software providing a Web service through the Internet by way of example. Examples of the user of the testing support apparatus 100 assumed in the following description are persons utilizing information outputted from the testing support apparatus 100, developers or maintenance staff of the software as the testing object, and the like.

When the user tests software by executing plural test scenarios including description of screen transition, the testing support apparatus 100 controls execution of the test scenarios so that the user can perform the testing efficiently. For example, when the user tests screens (hereinafter, referred to as screens under development), which are under development and described in predetermined source codes (Web description language (HTML (Hypertext Markup Language), XHTML (eXtensible Hypertext Markup Language), or XML (eXtensible Markup Language), for example) or various types of scripts (JavaScript (registered trademark) or the like)), the testing support apparatus 100 sets different execution priority levels for the plural test scenarios and executes the test scenarios in the order of the set execution priority levels. When software to be tested is of large scale and the test scenario to be executed is significantly long, a certain amount time is required after the initiation of the test scenario before the screen under development, which the user intends to verify, is executed in some cases. In such a case, the execution priority levels are set so as to preferentially execute the test scenario in which the screen under development is executed earlier than in the other test scenarios. This allows the screen under development to be executed early, and the user can acquire the test results of the screen under development quickly.

The testing support apparatus 100 sets the aforementioned execution priority levels based on a criterion specified by the user. The testing support apparatus 100 sets the execution priority levels so as to start the test for a screen under development early, for example. Alternatively, by acquiring information concerning the frequency of failure in a screen under development from an execution log obtained at past execution of the test scenarios, the testing support apparatus 100 sets the execution priority levels so that the test scenario with a high frequency of failure is executed with high priority. In such a manner, the testing support apparatus 100 sets the execution priority levels based on a criterion specified by the user and therefore tests a screen under development according to the user's need. To set the aforementioned execution priority levels, the testing support apparatus 100 divides the description of a test scenario on the basis of screens to efficiently know the description of the test scenario on the basis of screens.

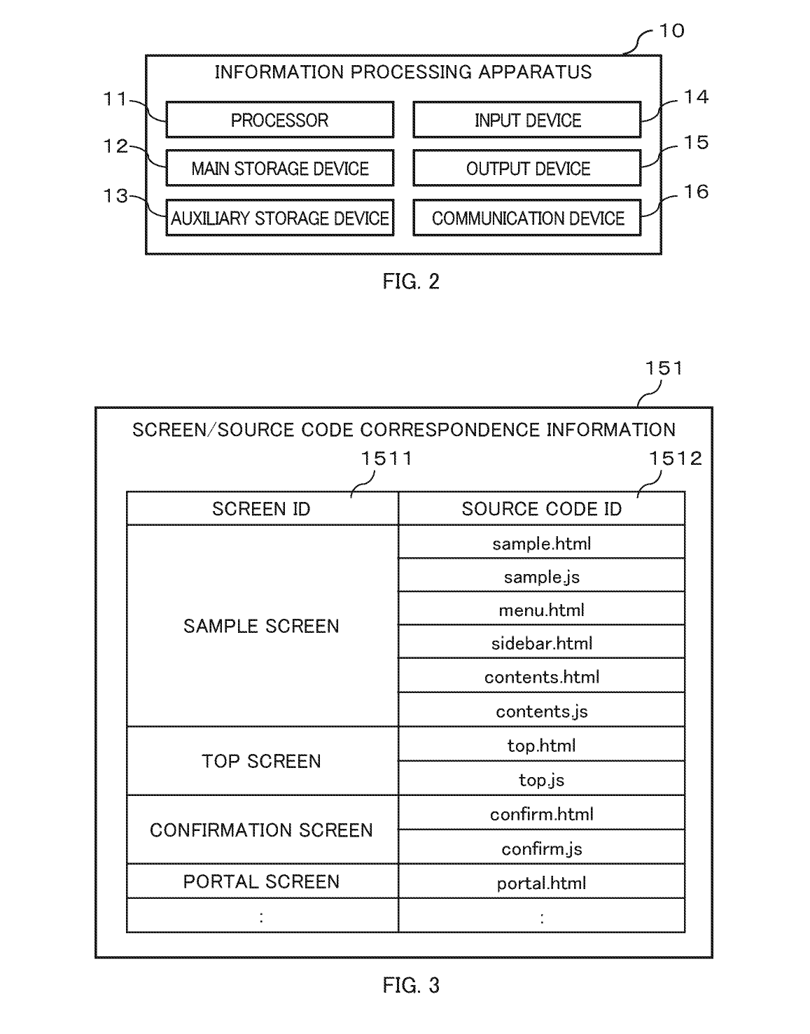

FIG. 2 is a block diagram of an information processing apparatus 10 (a computer) illustrated as an example of hardware implementing the testing support apparatus 100, project information management apparatus 200, and content provider apparatus 300. The information processing apparatus 10 may be configured to function as a network storage, for example. In FIG. 1, the testing support apparatus 100, project information management apparatus 200, and content provider apparatus 300 are composed of different hardware. However, two or more of these three apparatuses may be implemented by common hardware (a common platform). Alternatively, one or more of these three apparatuses may be implemented using a virtual information processing apparatus (a cloud server provided by a cloud system, for example).

As illustrated in FIG. 2, the information processing apparatus 10 includes a processor 11, a main storage device 12, an auxiliary storage device 13, an input device 14, an output device 15, and a communication device 16, which are coupled through a not-illustrated communication unit, such as a bus, so as to communicate with each other.

The processor 11 is composed of a central processing unit (CPU) or a micro-processing unit (MPU), for example. The processor 11 reads and executes a program stored in the main storage device 12 to implement various functions of the information processing apparatus 10. The main storage device 12 is a device storing programs and data, and the examples thereof are a read only memory (ROM), a random access memory (RAM), and NVRAM (non-volatile memory). The auxiliary storage device 13 is a hard disk drive, a solid state drive (SSD), an optical storage device, or a reader/writer for recording media, for example. Programs and data stored in the auxiliary storage device 13 are loaded onto the main storage device 12 when needed.

The input device 14 is a keyboard, a mouse, or a touch panel, for example. The output device 15 is a liquid crystal monitor, a liquid crystal display (LCD), a graphic card, or a speaker, for example. The communication device 16 is a communication interface communicating with another device through the communication network 5, and the examples thereof are a network interface card (NIC) and a wireless communication module. The input and output devices 14 and 15 are not necessarily required, and the information processing apparatus 10 may be configured to input and output information to and from another device through the communication device 16.

Subsequently, a description is given of the function provided for the testing support apparatus 100 and information (data) managed by the testing support apparatus 100 with reference to FIG. 1. As illustrated in FIG. 1, the testing support apparatus 100 includes a Web browser 101, a source code acquisition part 102, a screen/source code correspondence information generation part 103, a test scenario acquisition part 104, a test scenario dividing information generation part 105, a test scenario execution priority setting part 106, a test scenario execution part 107, an execution log acquisition part 108, and a storage unit 150. These functions are implemented by the processor 11 of the testing support apparatus 100 reading and executing programs stored in the main storage device 12. All of or some of the functions may be implemented by hardware. In addition to these functions, the testing support apparatus 100 may be configured to operate software, such as an operating system or a control program, to activate/manage each function or to manage data through a file system.

As illustrated in FIG. 1, the storage unit 150 stores screen/source code correspondence information 151, test scenario dividing information 152, test scenario execution priority information 153, test scenarios 154, execution logs 155, and source codes 156.

Among the functions illustrated in FIG. 1, for example, the Web browser 101 reads the source codes 156 in accordance with the test scenarios 154 and performs processes based on the source codes 156, including generation or display of screens (Web pages) describing the contents and play of the contents. At the aforementioned processes, the Web browser 101 properly sends a content acquisition request to the content provider apparatus 300 and acquires content data 302 from the content provider apparatus 300.

The source code acquisition part 102 properly acquires each source code 156 from the project information management apparatus 200 through the communication network 5. Each source code 156 is configured with data described in a Web description language or various types of scripts, for example. The testing support apparatus 100 manages the data on the basis of files which can be handled by the file system, for example.

The screen/source code correspondence information generation part 103 generates the screen/source code correspondence information 151 based on the source codes 156 (source files) stored in the storage unit 150. The screen/source code correspondence information 151 is described in detail later.

The test scenario acquisition part 104 properly acquires test scenarios 154 from the project information management apparatus 200 through the communication network 5. Each test scenario 154 includes plural steps (lines) described in a natural language, for example. The test scenario 154 includes operations which are performed for a Web page (screen) along a predetermined work scenario to cause screen transition. The test scenario 154 includes description to cause screen transition and description about what kind of test is performed for screens.

The test scenario dividing information generation part 105 divides each test scenario 154 into plural blocks on the basis of screens generated based on the source codes 156 and generates the test scenario dividing information 152 including the result of division. The test scenario dividing information 152 is described in detail later.

The test scenario execution priority setting part 106 sets the execution priority levels for the plural test scenarios 154 acquired by the test scenario acquisition part 104 and stores the result of setting the execution priority levels as the test scenario execution priority information 153. The specific method of setting the execution priority levels and the detail of the test scenario execution priority information 153 are described later.

The test scenario execution part 107 sequentially executes the test scenarios 154 in accordance with the execution priority levels set for the respective test scenarios 154. At executing the test scenarios 154, the test scenario execution part 107 controls the Web browser 101 and automatically executes the procedure of input operations based on the test scenarios 154, for example. The software implementing the function of the test scenario execution part 107 is Cucumber (registered trademark) or Turnip (registered trademark), for example. The test scenario execution part 107 may be configured to operate in cooperation with the Web server operating in the content provider apparatus 300, for example.

The execution log acquisition part 108 acquires information generated by the test scenario execution part 107 to execute the test scenarios 154 and stores the acquired information as the execution logs 155. The acquired information includes the start/end time of each step, occurrence of errors, information specifying the location of each error, the detail of each error, execution history, and the like.

The project information management apparatus 200 integratedly stores and manages information concerning projects (projects for development, maintenance, and designing) which the user is involved in. The project information management apparatus 200 includes: a project DB 202 in which information concerning projects is managed; and a DB management part 201 managing the project DB 202. The DB management part 201 includes a function as a database management system (DBMS), a distributed version management system, or the like, for example. The project information management apparatus 200 manages in the project DB 202, software and data items managed as a repository in association with metadata (specifications, design specifications, models, diagrams, information operation rules, and the like), for example.

The content provider apparatus 300 includes a content delivery part 301 storing and delivering content data 302. The content data 302 includes data described in a predetermined data format (character data, audio data, image data, video data, and the like), for example. When receiving the aforementioned content acquisition request, the content provider apparatus 300 sends the corresponding content data 302 to the testing support apparatus 100.

The test scenarios 154, execution logs 155, source codes 156, project DB 202, and content data 302 are unnecessarily arranged in the aforementioned manner. The arrangement manner of the data may be properly changed depending on the configuration of the information processing system 1.

### <Screen/Source Code Correspondence Information>

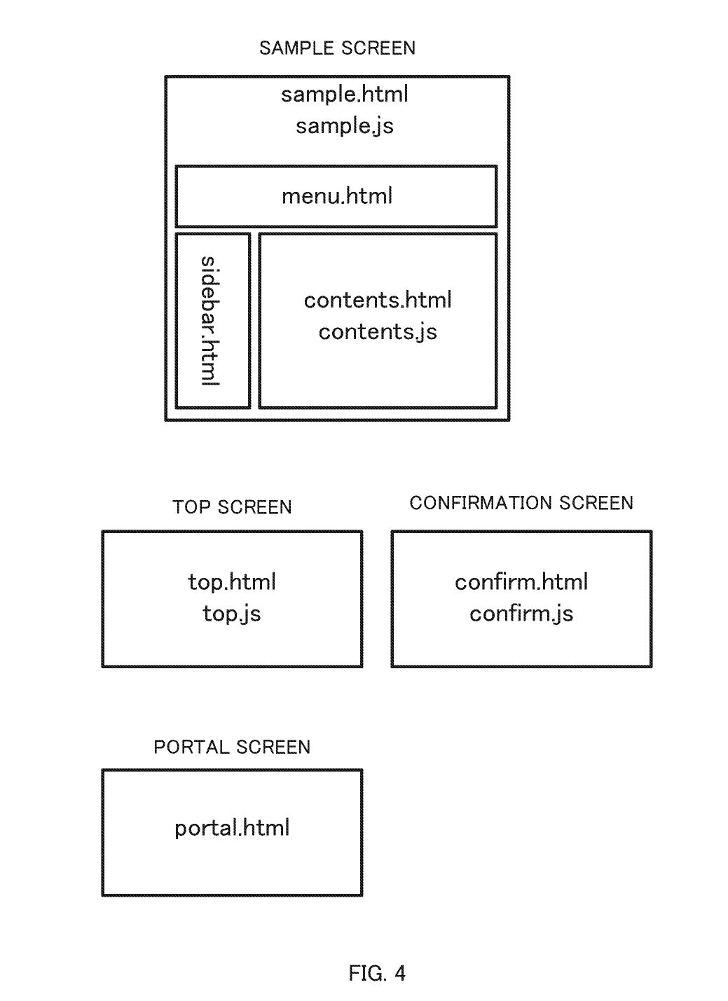

FIG. 3 illustrates an example of the screen/source code correspondence information 151, and FIG. 4 illustrates an example of the screen layout corresponding to the screen/source code correspondence information 151 of FIG. 3. As illustrated in FIG. 3, the screen/source code correspondence information 151 includes information representing the correspondence between screen IDs 1511 and source code IDs 1512. In this example, the screen IDs 1511 are screen names that the user uses as screen identifiers, and the source code IDs 1512 are file names of files including the respective source codes. The correspondence between the screen IDs 1511 and the source code IDs 1512 varies depending on the form of the project, the configuration of the information processing system 1, and the like. Moreover, the correspondence between the screen IDs 1511 and the source code IDs 1512 is not always one to one, and one screen is composed of plural source codes (source files) in some cases like “Sample screen” in FIG. 4.

In this example, the screen ID 1511 “Sample screen” corresponds to source files (source codes) including sample. html, sample.js, menu.html, sidebar.html, contents.html, and contents.js as illustrated in FIGS. 3 and 4. As illustrated in FIG. 4, in Sample screen, menu.html, sidebar.html, and contents.html are used in sample.html. In this example, the behavior of a single or plural screen components described in sample.html is described in sample.js, and the behavior of a single or plural screen components described in contents.html is described in contents.js.

The screen ID 1511 “Top screen” corresponds to the source files (source codes) of top.html and top.js. The behavior of a single or plural screen components described in top.html is described in top.js.

The screen ID 1511 “Confirmation screen” corresponds to the source files (source codes) of confirm.html and confirm.js. The behavior of a single or plural screen components described in confirm.html is described in confirm.js.

The screen ID 1511 “Portal screen” corresponds to the source file (source code) of portal.html. The behavior of a single or plural screen components described in portal.html does not need to be defined, and there is no script file corresponding to Portal screen.

### <Test Scenario Dividing Information>

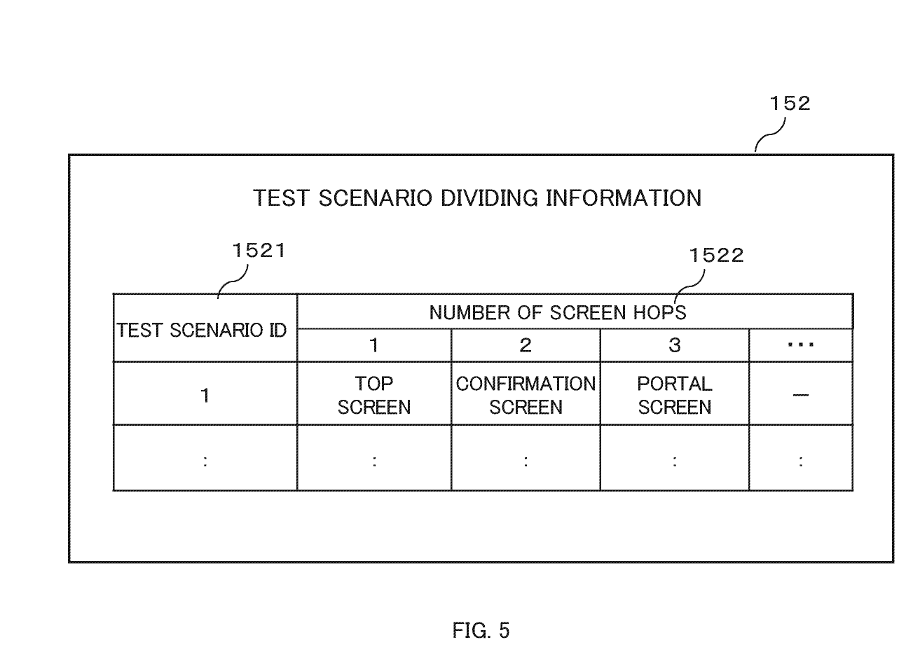

FIG. 5 illustrates an example of the test scenario dividing information 152. Test scenario IDs 1521 of FIG. 5 are set to test scenario IDs which are identifiers given to the respective test scenarios 154. Numbers 1522 of screen hops are set to information representing the order of blocks in the test scenario 154, the blocks being obtained by dividing the description of each test scenario 154 on the basis of screens. In FIG. 5, each block is specified by a screen name described in the corresponding one of the fields provided for the respective numbers of screen hops of 1, 2, 3 . . . .

The test scenario dividing information 152 illustrated in FIG. 5 represents that the description of a test scenario 154 with a test scenario ID of 1 is divided into three blocks: a block concerning Top screen, a block concerning Confirmation screen, and a block concerning Portal screen. The test scenario dividing information 152 represents that: when the test scenario 154 with a test scenario ID of 1 is executed, Top screen is tested first, and the transition from Top screen to Confirmation screen is performed. After Confirmation screen is then tested, the screen transition from Confirmation screen to Portal screen is performed, followed by the test for Portal screen.

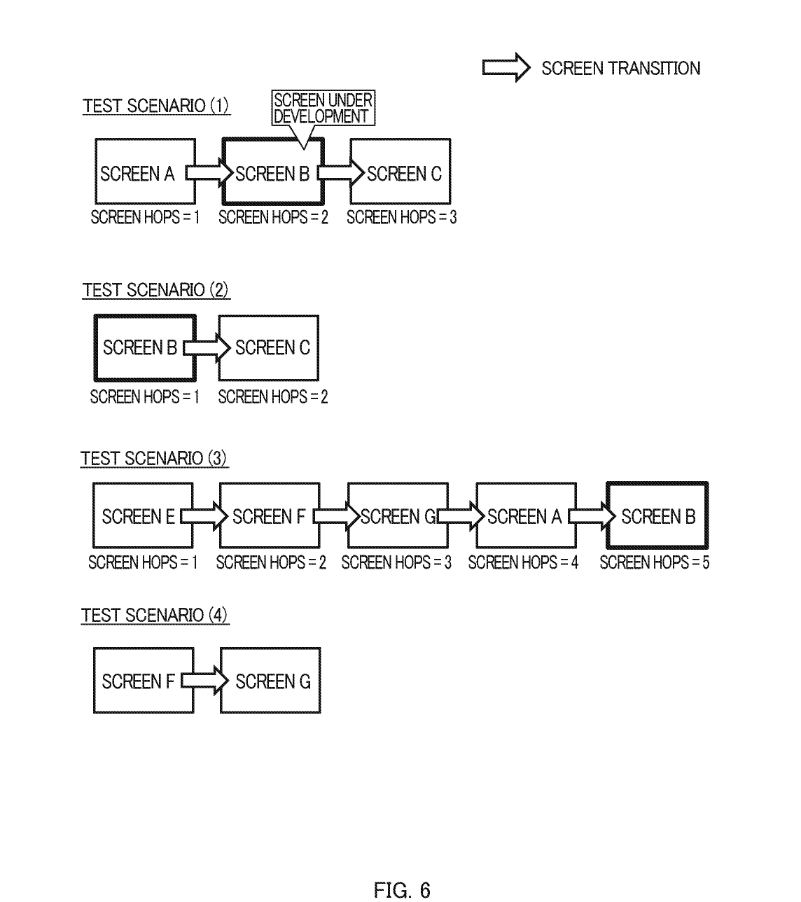

With reference to FIG. 6, the number of screen hops is described specifically. In FIG. 6, white arrows indicate transition of screens. In this example, under test scenario (1), screen testing is performed for screen A, screen B, and screen C in this order. Under test scenario (2), screen testing is performed for screen B and screen C in this order. Under test scenario (3), screen testing is performed for screen E, screen F, screen G, screen A, and screen B in this order. Under test scenario (4), screen testing is performed for screen F and screen G in this order.

The number of screen hops for each screen indicates the number of screens which are tested from the beginning of the scenario until the screen of interest is tested. In FIG. 6, for example, the number of screen hops of screen B is 2 in test scenario (1), is 1 in test scenario (2), and 5 in test scenario (3). Test scenario (4) does not include screen B as the object to be tested, and the number of screen hops of screen B is not determined (none) in this case.

When the screen to be tested is screen B and execution of the test scenarios is prioritized based on the number of screen hops as the criterion, execution of the test scenarios is prioritized in order of test scenario (2), test scenario (1), and test scenario (3).

### <Test Scenario Execution Priority Information>

The test scenario execution priority information 153 includes the execution priority levels of the test scenarios 154 determined by the test scenario execution priority setting part 106 for each screen based on each criterion.

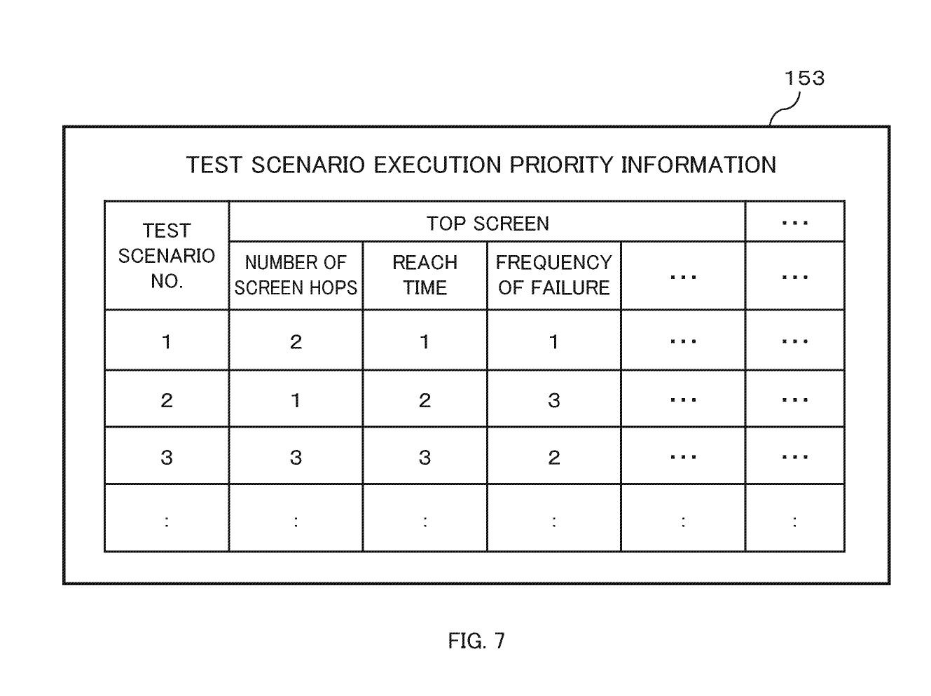

FIG. 7 illustrates an example of the test scenario execution priority information 153. The test scenario execution priority information 153 includes information representing the execution priority levels of the test scenarios 154 for each screen based on each criterion. In FIG. 7, the test scenarios 154 are prioritized for Top screen based on three criteria (the number of screen hops, reach time, and frequency of failure).

In FIG. 7, the execution priority levels based on the number of screen hops are set to the number of screen hops of Top screen.

In FIG. 7, moreover, the execution priority levels based on the reach time are determined by the test scenario execution priority setting part 106 based on the execution log 155 acquired at past execution of the test scenarios 154. For example, the test scenario execution priority setting part 106 sets the execution priority levels for the respective test scenarios 154 based on the reach time so that the shorter the time (start timing) to reach the screen (the time from the beginning of the test scenario 154 to the start of execution of the block for the screen), the higher the execution priority.

In FIG. 7, moreover, the execution priority levels based on the frequency of failure are set by the test scenario execution priority setting part 106 based on the execution logs 155 acquired at past execution of the test scenarios 154. For example, the test scenario execution priority setting part 106 sets the execution priority levels for the respective test scenarios 154 based on the frequency of failure so that the higher the frequency of failure concerning the screen of interest, the higher the execution priority levels of the test scenarios 154.

Herein, when the test of a specific screen under development needs to be started early, for example, the user selects any one of the number of screen hops and reach time as the criterion to prioritize the test scenarios 154. When it is necessary to find failure in a specific screen under development early, the user selects the frequency of failure as the criterion to prioritize the test scenarios 154.

The above criteria for priority are shown just way of example, and the test scenarios 154 may be prioritized based on another criterion. Moreover, the test scenarios 154 may be prioritized by collectively judging the orders of execution priority obtained based on plural criterion for priority, for example. When the orders of execution priority based on two criteria are reversed to each other, the order of execution priority based on one of the two criteria is preferentially selected, for example. The test scenario 154 not including the description concerning the screen to be tested may be exempted from the objects to be executed. In this case, a predetermined symbol such as “-” is set in the field of the corresponding test scenario in the test scenario execution priority information 153, for example.

### <Description of Processing>

Next, a description is given of a process performed in the thus-configured information processing system 1.

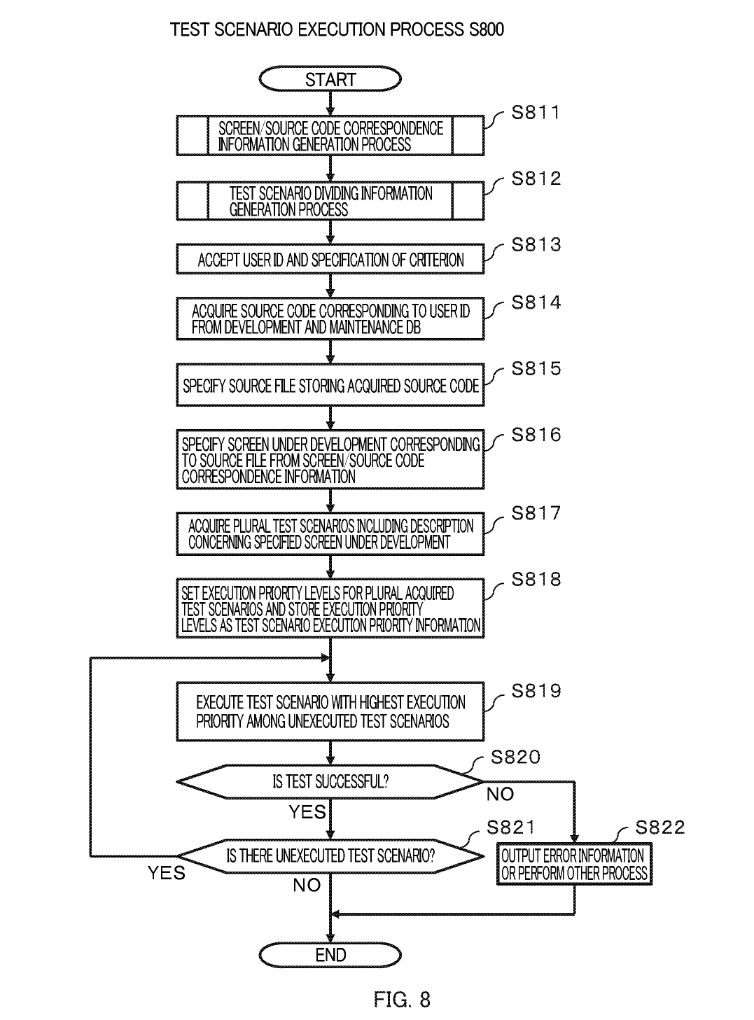

FIG. 8 is a flowchart for explaining a process performed by the testing support apparatus 100 at testing of screens displayed by software (hereinafter, referred to as a test scenario execution process S800).

The testing support apparatus 100 first performs a process to generate the screen/source code correspondence information 151 (hereinafter, referred to as a screen/source code correspondence information generation process S811) and a process to generate the test scenario dividing information 152 (hereinafter, referred to as a test scenario dividing information generation process S811) (S811, S812). These processes are described in detail later.

Subsequently, the testing support apparatus 100 accepts a user ID (a developer name concerning the development of screen underdevelopments or the like) and specification of the criterion (S813). The user can specify one or plural criteria.

Subsequently, the test supporting apparatus 100 acquires the source codes associated with the user ID accepted in S813 from the project DB 202 of the project information management apparatus 200 and stores the same as the source codes 156 (S814). For example, the testing support apparatus 100 may be configured to narrow the source codes to be acquired from the project DB 202 based on the information accepted from the user, such as development date and time (not described in this example).

The testing support apparatus 100 then specifies source files storing the acquired source codes (S815) and specifies screens corresponding to the source files (hereinafter referred to as screen under developments) based on the screen/source code correspondence information 151 (S816).

Subsequently, the testing support apparatus 100 acquires the test scenarios 154 including the description concerning the screen under developments specified in S816 with reference to the test scenario dividing information 152 (S817). In this example, the testing support apparatus 100 acquires plural test scenarios 154.

The testing support apparatus 100 sets execution priority levels for the plural test scenarios 154 acquired in S817 based on the criterion accepted in S813 and stores the result of setting as the test scenario execution priority information 153 (S818).

The testing support apparatus 100 then executes the test scenario having the highest execution priority among the unexecuted test scenarios 154 (S819).

The testing support apparatus 100 then determines whether the test concerning the screen under development is successfully executed (S820). When the determination is true (YES in S820), the process proceeds to S821. When the determination is false (NO in S820), the process proceeds to S822, and the testing support apparatus 100 performs a process to output error information and the like and then terminates the execution of the test scenario 154. The execution of the test scenario 154 may be terminated when the test concerning the screen under development ends as described above or may be maintained to the end of the test scenario 154. When the execution of the test scenario 154 is terminated when the test concerning the screen under development ends like the former configuration, the user can acquire the result of testing early, so that the time taken to detect failure can be shortened.

In S821, the testing support apparatus 100 determines whether there is an unexecuted test scenario 154 among the test scenarios 154 concerning the screen under development. When the determination is true (YES in S821), the process returns to S819, and the testing support apparatus 100 starts another unexecuted test scenario 154. When the determination is false (NO in S821), the testing support apparatus 100 terminates the test scenario execution process S800.

In the test scenario execution process S800 described above, when the pattern of screen transition of a certain test scenario 154 overlaps whole or part of the pattern of screen transition of another test scenario 154, the testing support apparatus 100 may be configured to properly select test scenarios 154 to be executed so as not to execute the overlapping patterns for improvement in the efficiency of testing. In FIG. 6, for example, the pattern of screen transition of test scenario (1) is screen A->screen B->screen C, and the pattern of screen transition of test scenario (2) is screen B->screen C. Test scenarios (1) and (2) both include the pattern of screen transition of screen B->screen C. In this case, the testing support apparatus 100 does not execute test scenario (2), for example.

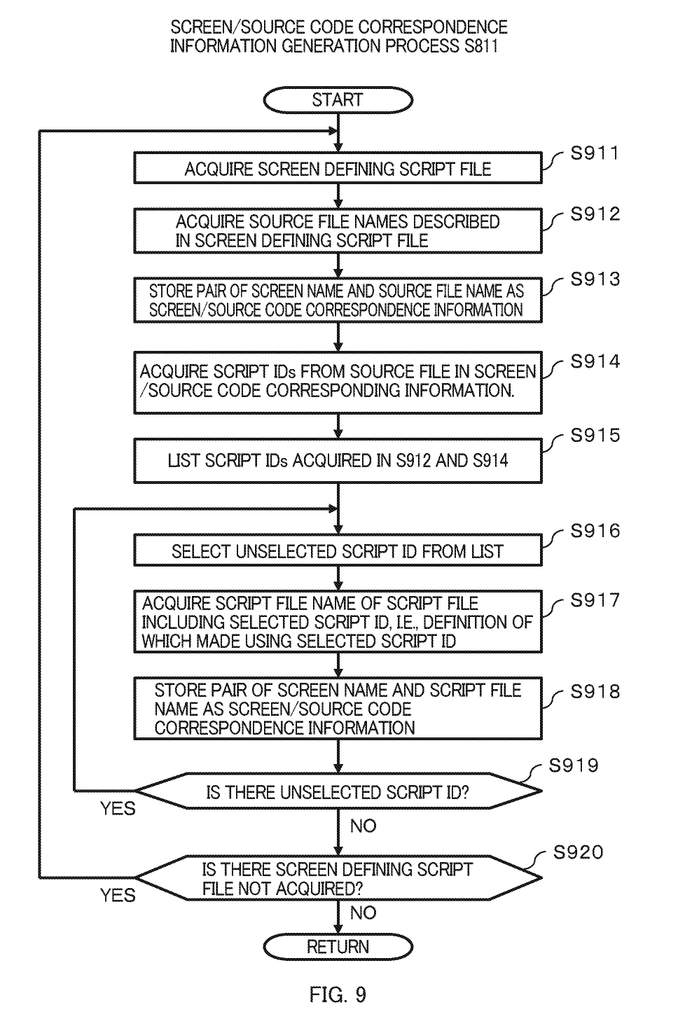

FIG. 9 is a flowchart for explaining the detail of the screen/source code correspondence information generation process S811 of FIG. 8. Hereinafter, the screen/source code correspondence information generation process S811 is described in detail.

The testing support apparatus 100 first acquires a source code that defines a screen (hereinafter, referred to as a screen defining script file) from the stored source codes 156 (source files). For example, the testing support apparatus 100 acquires a screen defining script file that describes a pair of the screen name and source file name (a HTML file name, a HTML file ID, a script files name, or a script ID, for example) from the source codes 156 (source files) (S911).

The testing support apparatus 100 then acquires a source file name associated with the screen name from the screen defining script file acquired in S911 (S912) and stores the pair of screen name and source file name as the screen/source code correspondence information 151 (S913).

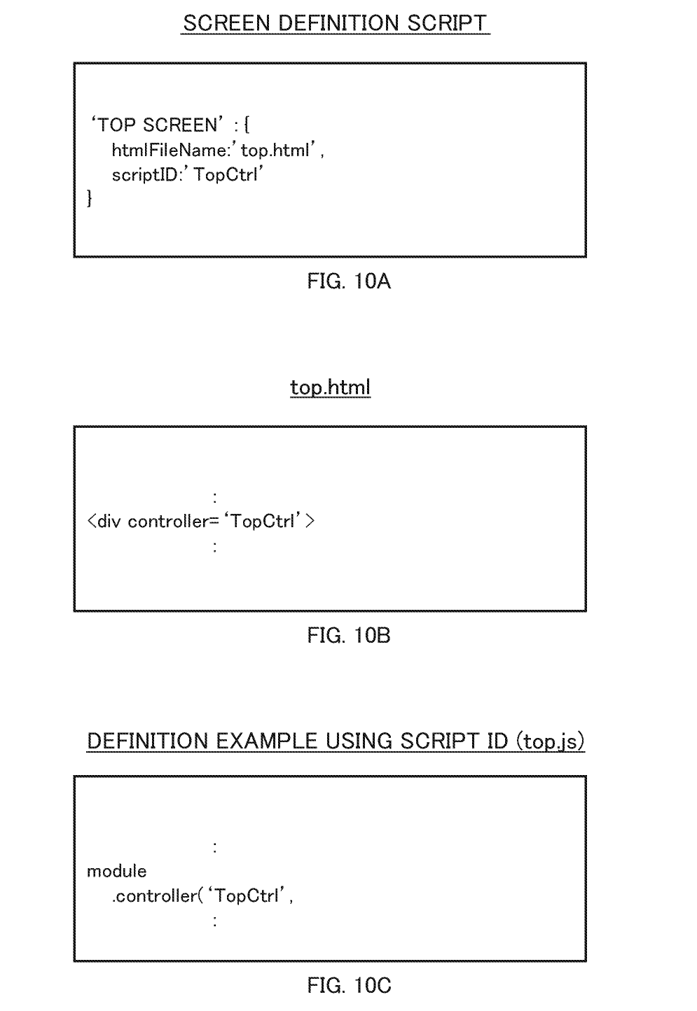

FIG. 10A illustrates an example of screen defining scripts. This screen defining script includes “Top screen” as the screen name and “top.html” as the source file name (HTML file name). Moreover, the screen defining script includes “TopCtrl” as the script ID corresponding to “Top screen”. When the screen defining script includes a script ID instead of a script file name like this example, the script file name is specified based on the script ID in the following process.

Back to FIG. 9, the testing support apparatus 100 then analyses the source file described in the screen/source code correspondence information 151 and acquires a script ID (S914).

FIG. 10B illustrates a description example of the source file (HTML file) with a file name of “top.html” described in the screen defining script of FIG. 10A. In this example, “TopCtrl” is set to “controller” attribute. The testing support apparatus 100 can efficiently acquire a script ID from a source file if attributes to which script IDs can be set are previously stored, for example. The script IDs may be acquired based on information other than attributes.

Back to FIG. 9, the testing support apparatus 100 lists the script IDs acquired in S912 and S914 (S915).

The testing support apparatus 100 selects a script ID not selected yet from the script IDs listed in S915.

The testing support apparatus 100 searches the stored source codes 156 (source files) for a script file including the selected script ID and acquires the obtained name (script file name) of the script file (S917). The testing support apparatus 100 stores the pair of the acquired script file name and the screen name described in the screen defining script file as the screen/source code correspondence information 151 (S918).

FIG. 10C illustrates an example of a script file including (defining) script IDs. In this script file “top.js”, “TopCtrl” is defined as the script ID.

Back to FIG. 9, the testing support apparatus 100 determines whether there is a script ID not selected in S916 among the script IDs listed in S915 (S919). When the determination is true (YES in S919), the process returns to S916. When the determination is false (NO in S919), the process proceeds to S920.

In S920, the testing support apparatus 100 determines whether there is a screen defining script file not acquired in S911 among the stored source files 214 (S920). When the determination is true (YES in S920), the process returns to S911, and the testing support apparatus 100 acquires another screen defining script file and performs the same process for the newly acquired screen-defining script file. When the determination is false (NO in S920), the process proceeds to S912 of FIG. 8.

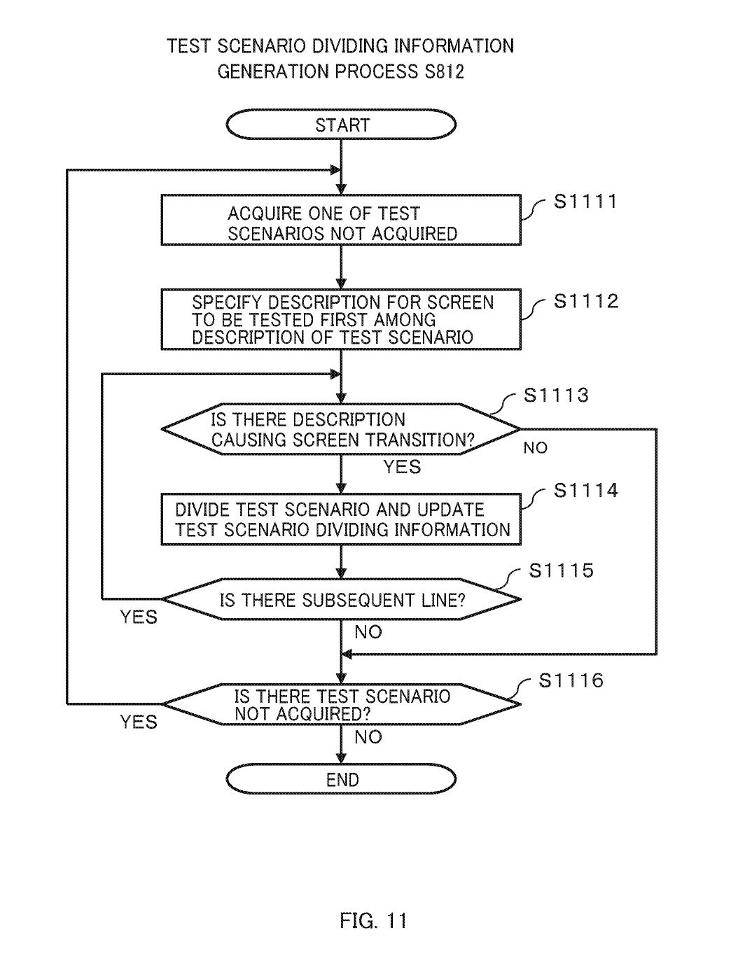

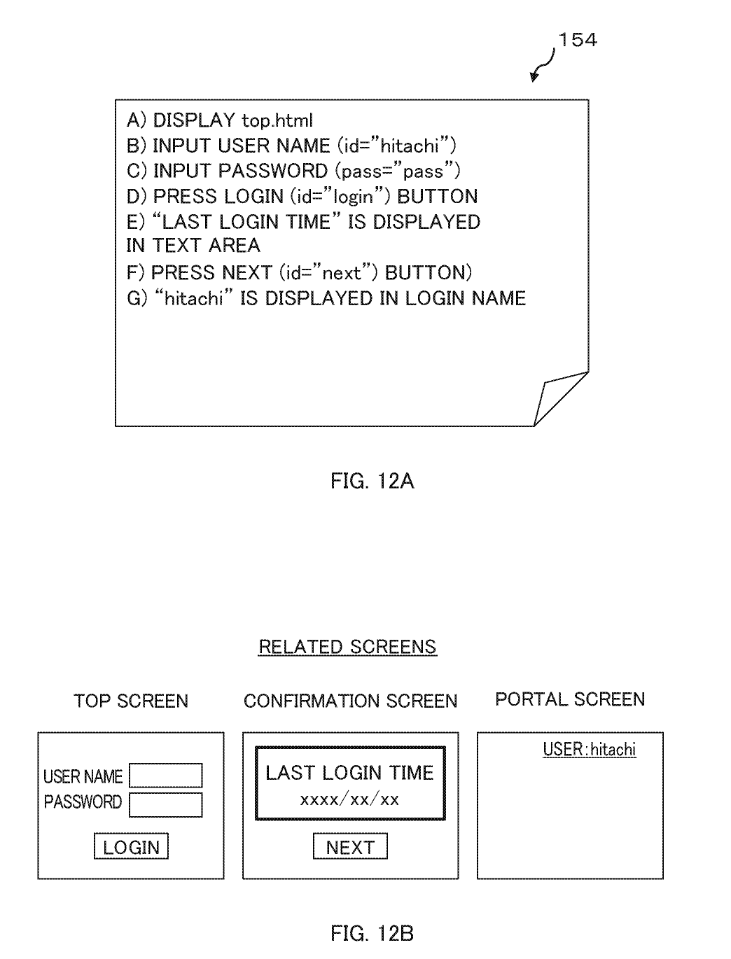

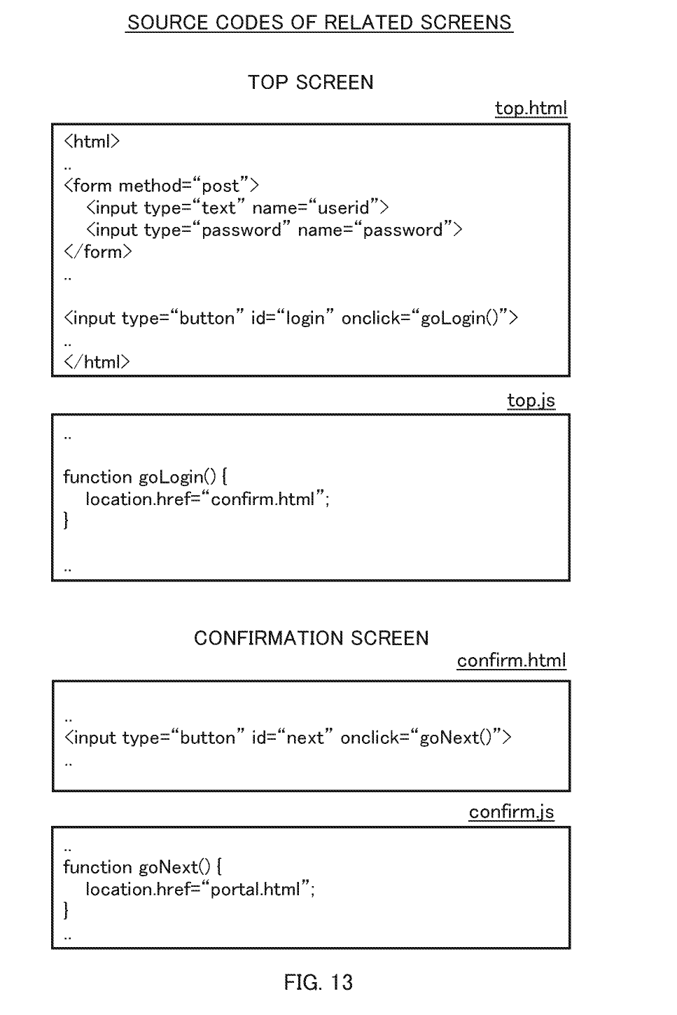

FIG. 11 is a flowchart for explaining the detail of the test scenario dividing information generation process S812 of FIG. 8. FIG. 12A is a test scenario 154 used for explaining the test scenario dividing information generation process S812. FIG. 12B is examples of screens related to the test scenario 154 of FIG. 12A. FIG. 13 is examples of source codes corresponding to each screen of FIG. 12B.

As illustrated in FIG. 12A, the test scenario 154 illustrated by way of example includes the contents of A) to G).

A) DISPLAY top.html
B) INPUT USER NAME (id=“hitachi”)
C) INPUT PASSWORD (pass=“pass”)
D) PRESS LOGIN (id=“login”) BUTTON

### E) LAST LOGIN TIME IS DISPLAYED IN THE TEXT AREA

F) PRESS NEXT (id=“next”) BUTTON
G) “hitachi” IS DISPLAYED IN LOGIN NAME

According to this test scenario 154, after Top screen is tested, the screen transition from Top screen to Confirmation screen is performed. Confirmation screen is then tested, and screen transition from Confirmation screen to Portal screen is performed. Finally, Portal screen is tested. As illustrated in this example, the description of the test scenario 154 does not include information representing the locations partitioning the screens. It is therefore impossible to directly specify the lines at which testing of a certain screen starts and ends.

Hereinafter, a description is given of the test scenario dividing information generation process S812 with reference to FIG. 11. As illustrated in FIG. 11, the testing support apparatus 100 first acquires a test scenario 154 not acquired yet among the stored test scenarios 154 (S1111).

The testing support apparatus 100 then specifies in the acquired test scenario 154, the description concerning the screen which is to be tested at first when the acquired test scenario 154 is executed (S1112). When the test scenario 154 is a test scenario 154 illustrated in FIG. 12A by way of example, based on the description of “top.html” in “DISPLAY top.html” and the screen/source code correspondence information 151, the testing support apparatus 100 determines that testing of Top screen is started. The method of the testing support apparatus 100 determining the contents executed by the test scenario 154 is not limited. The testing support apparatus 100 may determine the start of testing based on the description such as “select a window including xxx button”, “selects a window with a title of xxx”, and the like.

Subsequently the testing support apparatus 100 determines whether the subsequent lines include description causing screen transition (S1113). When the determination is true (YES in S1113), the process proceeds to S1114. When the determination is false (NO in S1113), the process proceeds to S1116.

For example, when the test scenario 154 is the test scenario illustrated in FIG. 12A by way of example, the testing support apparatus 100 determines that the line D) “PRESS LOGIN (id=“login”) BUTTON” causes screen transition by interpreting the line D) as follows: based on the description of top.html as the source file of Top screen, goLogin function is called when id=“login” button is pressed; and based on the description of top.js as the source file of Top screen, screen transition to “confirm.html” is performed. In this process, from the screen/source code correspondence information 151, the testing support apparatus 100 specifies Confirmation screen as the transition destination when the Login button is pressed.

In S1114, the testing support apparatus 100 divides the description of the test scenario 154 into blocks on the basis of screens and stores the results of division as the test scenario dividing information 152.

In S1115, the testing support apparatus 100 determines whether there is a subsequent line in the acquired test scenario 154. When the determination is true (YES in S1115), the process returns to S1113, and the testing support apparatus 100 performs the process following S1113 for the subsequent line. When the determination is false (NO in S1115), the process proceeds to S1116.

In the test scenario 154 illustrated by way of example in FIG. 12A, the testing support apparatus 100 determines that the subsequent line “F) Press Next (id=“next”) button” is the description causing screen transition. Moreover, the testing support apparatus 100 specifies that, based on the description of confirm.html as the source file of Confirmation screen (illustrated in FIG. 13), goNext function is called when id=“next” button is pressed; and based on the description of confirm.js as the source file of Confirm screen, the transition destination is portal.html.

In S1116, the testing support apparatus 100 determines whether there is a test scenario 154 not acquired. When the determination is true (YES in S1116), the process returns to S1111. When the determination is false (NO in S1116), the process proceeds to S813 of FIG. 8.

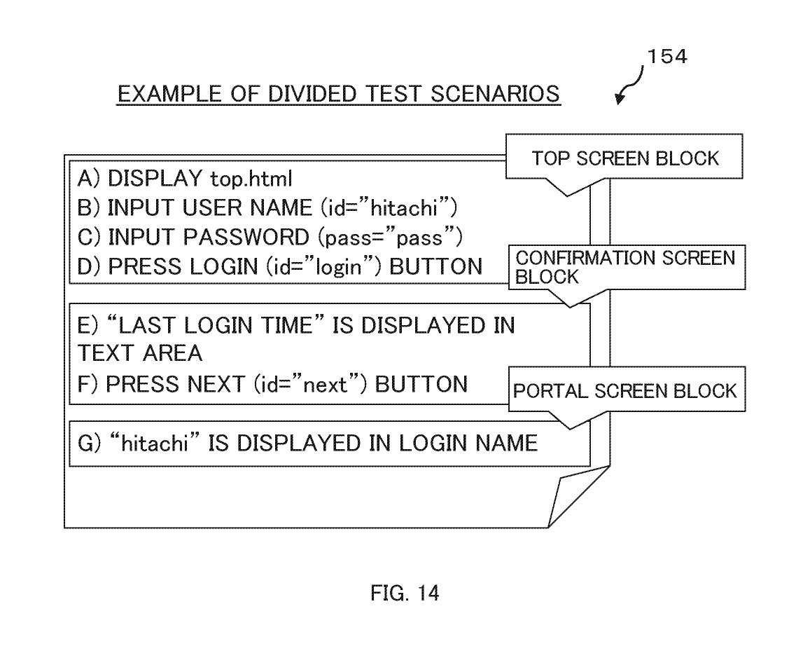

By the test scenario dividing information generation process S812, the test scenario 154 illustrated in FIG. 12A is divided into three blocks as illustrated in FIG. 14: a block concerning Top screen (A) to B)); a block concerning Confirmation screen (E) to F)); and a block concerning Portal screen (G)).

In the above description, the test scenario 154 is divided with reference to the description concerning buttons as the screen components but may be divided with reference to another kind of description of link components or the like including characters and images.

As described in detail hereinabove, the testing support apparatus 100 of the embodiment generates the test scenario dividing information 152 by dividing the description of the test scenario 154 into plural blocks in terms of screens. The testing support apparatus 100 is thereby enabled to know the description of each test scenario 154 on a screen basis and to specify part of the description corresponding to the screen under development in the test scenario 154. The testing support apparatus 100 is therefore enabled to determine which test scenario 154 needs to be preferentially executed for the purpose of acquiring the result of testing of the screen under development early or which test scenario 154 needs to be preferentially executed for the purpose of acquiring information concerning failure of screen under developments. By prioritizing the plural test scenarios in accordance with the result of determination, the testing support apparatus 100 is enabled to provide information required by the user efficiently and quickly.

When the user intends to acquire the result of testing of screen B as the screen under development and to prioritize the four test scenarios 154 illustrated in FIG. 6 based on the number of screen hops, the testing support apparatus 100 executes test scenario (2), test scenario (1), and test scenario (3) in this order. Compared with the case where test scenario (4), test scenario (1), test scenario (2), and test scenario (3) are executed in this order, test scenario (4) is not executed, resulting in cutting the time required to execute test scenario (4). Moreover, test scenario (2) is executed prior to test scenario (1), so that the time taken to test screen A in test scenario (1) is not required. The user can therefore acquire the result of testing of screen B early.

Hereinabove, the present invention made by the inventor is specifically described based on the embodiment. However, it is certain that the present invention is not limited to the aforementioned embodiment and can be variously changed without departing from the scope of the invention. For example, the embodiment is described in detail for easy understanding of the present invention and is unnecessarily limited to the system including all of the components described above. Moreover, the components of the embodiment can be removed or replaced or further include another component.

The present invention is applicable to various purposes including the purpose of quickly displaying a particular screen at reviewing screens displayed by software, for example.

Moreover, a part or all of each component, function, processing part, processing unit, and the like described above may be implemented by hardware and, for example, may be designed with integrated circuits or the like. Alternatively, each component, function, and the like described above may be implemented by software in such a manner that the processor interprets and executes a program implementing each function thereof. The information of programs, tables, and files implementing the functions and the like can be placed in a recording device such as a memory, a hard disk, a solid state drive (SSD) or a recording medium such as an IC card, an SD card, or a DVD.

The drawings described above illustrate the control and information lines which are thought to be necessary for explanation and do not illustrate all of the control and information lines necessary for implementation. It can be considered that almost all of the components are coupled to each other.

What is claimed is:

1. A testing support apparatus as an information processing apparatus configured to support testing of software, comprising:
a storage unit configured to store
a plurality of test scenarios including description concerning transition of screens,
source codes constituting the software, and
screen/source code correspondence information representing correspondence between the screens and the source codes related to generation of the screens;
a test scenario division part configured to generate test scenario dividing information being information including the results of dividing the description of each of the test scenarios into a plurality of blocks in terms of the screens; and
a test scenario execution priority setting part configured to set execution priority levels for the plurality of test scenarios based on the test scenario dividing information.

2. The testing support apparatus according to claim 1, wherein
the test scenario execution priority setting part sets the execution priority levels for the plurality of test scenarios for each of the screens based on a criterion.

3. The testing support apparatus according to claim 2, wherein
the test scenario execution priority setting part sets the execution priority levels for the plurality of test scenarios based on the criterion that one of the plurality of test scenarios in which a particular one of the screens starts to be tested early is executed prior to the others.

4. The testing support apparatus according to claim 3, wherein
the storage unit further stores an execution log of each of the plurality of test scenarios, and
the test scenario execution priority setting part acquires information specifying timing when the particular screen is started from the execution log of each of the test scenarios and sets the execution priority levels for the plurality of test scenarios based on the acquired timing.

5. The testing support apparatus according to claim 2, wherein
the storage unit further stores an execution log of each of the plurality of test scenarios, and
the test scenario execution priority setting part acquires information about frequency of failure concerning a particular one of the screens from the execution log of each of the test scenarios and sets the execution priority levels for the plurality of test scenarios based on the criterion that one of the test scenarios with a high frequency of failure concerning the particular screen is executed prior to the other test scenarios.

6. The testing support apparatus according to claim 1, wherein
the storage unit stores the source codes in a form of files,
the apparatus further comprising
a screen/source code correspondence information generation part configured to acquire a file name of the source code related to particular one of the screens from the source codes including description defining the particular one of the screens and generate information on the correspondence between the particular screen and the file name associated with each other as the screen/source code correspondence information.

7. The testing support apparatus according to claim 1, wherein
the test scenario division part divides each test scenario based on description causing transition of screens in the test scenario.

8. The testing support apparatus according to claim 1, further comprising a test scenario execution part configured to sequentially execute the plurality of test scenarios in accordance with the execution priority levels.

9. The testing support apparatus according to claim 8, wherein
the test scenario execution part stops execution of each test scenario when execution of the block corresponding to particular one of the screens is completed.

10. The testing support apparatus according to claim 8, wherein
when the pattern of the transition of screens of one of the test scenarios overlaps whole or part of the pattern of the transition of screens of another one of the test scenarios, the test scenario execution part selects the test scenarios to be executed so as not to duplicate testing for the pattern.

11. A method of supporting testing of software, comprising causing an information processing apparatus to:
store
a plurality of test scenarios including description concerning transition of screens,
source codes constituting the software, and
screen/source code correspondence information representing correspondence between the screens and the source codes related to generation of the screens;
generate test scenario dividing information which is information including the results of dividing the description of each of the test scenarios into a plurality of blocks in terms of the screens; and
set execution priority levels for the plurality of test scenarios based on the test scenario dividing information.

12. The method of supporting testing of software according to claim 11, wherein the information processing apparatus sets the execution priority levels for the plurality of test scenarios for each of the screens based on a criterion.

13. The method of supporting testing of software according to claim 12, wherein the information processing apparatus sets the execution priority levels for the plurality of test scenarios based on such a criterion that one of the plurality of test scenarios in which a particular one of the screens starts to be tested early is executed prior to the others.

14. The method of supporting testing of software according to claim 13, wherein the information processing apparatus further stores an execution log of each of the plurality of test scenarios,
acquires information specifying timing when the particular screen is started from the execution log of each of the test scenarios, and
sets the execution priority levels for the plurality of test scenarios based on the acquired timing.

15. A non-transitory computer-readable medium storing a program for supporting testing of software, the program causing an information processing apparatus to:
store
a plurality of test scenarios including description concerning transition of screens,
source codes constituting the software, and
screen/source code correspondence information representing correspondence between the screens and the source codes related to generation of the screens;
generate test scenario dividing information which is information including the results of dividing the description of each of the test scenarios into a plurality of blocks in terms of the screens; and
set execution priority levels for the plurality of test scenarios based on the test scenario dividing information.
